(19) United States
(12) Patent Application Publication
(10) Pub. No.: US 2015/0230497 A1
(43) Pub. Date: Aug. 20, 2015

(54) PRODUCTION OF PULSE PROTEIN PRODUCT USING CALCIUM CHLORIDE EXTRACTION ("YP702")

(71) Applicant: BURCON NUTRASCIENCE (MB) CORP.,, Winnipeg (CA)

(72) Inventors: Kevin I. Segall, Winnipeg (CA); Martin Schweizer, Winnipeg (CA)

(21) Appl. No.: 14/433,164

(22) PCT Filed: Sep. 30, 2013
(86) PCT No.: PCT/CA2013/000834

§ 371 Date: Apr. 2, 2015

Related U.S. Application Data
(60) Provisional application No. 61/708,803, filed on Oct. 2, 2012.

(51) Int. Cl. A23J 1/14; A23L 2/66; A23L 1/305

(52) U.S. Cl. CPC A23J 1/14; A23L 1/3055; A23L 2/66; A23V 2002/00

(57) ABSTRACT

A pulse protein product having a protein content of at least about 60 wt % (N×6.25) d.b., preferably a pulse protein isolate having a protein content of at least about 90 wt % (N×6.25) d.b., is prepared from a pulse protein source material by extraction of the pulse protein source material with an aqueous calcium salt solution, preferably calcium chloride solution, to cause solubilization of pulse protein from the protein source and to form an aqueous pulse protein solution, separating the aqueous pulse protein solution from residual pulse protein source, optionally concentrating the aqueous pulse protein solution while maintaining the ionic strength substantially constant by using a selective membrane technique, optionally diafiltering the optionally concentrated pulse protein solution, and optionally drying the optionally concentrated and optionally diafiltered pulse protein solution.

### FIELD OF INVENTION

This present invention is concerned with the preparation of pulse protein products.

### BACKGROUND TO THE INVENTION

In U.S. patent applications Ser. No. 13/103,528 filed May 9, 2011 (US Patent Publication No. 2011-0274797 published Nov. 10, 2011), Ser. No. 13/289,264 filed Nov. 4, 2011 (US Patent Publication No. 2012-0135117 published May 31, 2012), Ser. No. 13/556,357 filed Jul. 24, 2012 (US Patent Publication No. 2013-0189408 published Jul. 25, 2013) and Ser. No. 13/642,003 filed Jan. 7, 2013, assigned to the assignee hereof and the disclosures of which are incorporated herein by reference, there is described the production of pulse protein products having a protein content of at least about 60 wt % (N×6.25) d.b., preferably at least about 90 wt % (N×6.25) d.b., more preferably at least about 100 wt % (N×6.25) d.b., that are completely soluble at low pH values, producing solutions, preferably transparent solutions, that are heat stable and, therefore, may be used for protein fortification of, in particular, soft drinks and sports drinks, as well as other aqueous systems, without precipitation of protein.

The pulse protein product described therein has a unique combination of parameters, not found with other pulse protein products. The product is completely soluble in aqueous solution at acid pH values of less than about 4.4 and is heat stable in that pH range permitting thermal processing of the aqueous solution of the products. Given the complete solubility of the product, no stabilizers or other additives are necessary to maintain the protein in solution or suspension.

The pulse protein product in one aspect, is produced by a process which comprises:
(a) extracting a pulse protein source with an aqueous calcium salt solution, preferably an aqueous calcium chloride solution, to cause solubilization of pulse protein from the protein source and to form an aqueous pulse protein solution,
(b) separating the aqueous pulse protein solution from residual pulse protein source,
(c) optionally diluting the aqueous pulse protein solution,
(d) adjusting the pH of the aqueous pulse protein solution to a pH of about 1.5 to about 4.4, preferably about 2 to about 4, to produce an acidified pulse protein solution,
(e) optionally clarifying the acidified pulse protein solution if it is not already clear,
(f) optionally concentrating the aqueous pulse protein solution while maintaining the ionic strength substantially constant by using a selective membrane technique,
(g) optionally diafiltering the optionally concentrated pulse protein solution, and
(h) optionally drying the optionally concentrated and optionally diafiltered pulse protein solution.

The pulse protein product preferably is an isolate having a protein content of at least about 90 wt %, preferably at least about 100 wt %.

### SUMMARY OF THE INVENTION

It has now been found that calcium chloride extracts of pulse protein source may be processed by alternative procedures to provide substantially equivalent pulse protein products, having a protein content of at least about 60 wt % (N×6.25) d.b., that are soluble at low pH and produce solutions, preferably transparent solutions that are heat stable at low pH values, and, therefore, may be used for protein fortification of, in particular, soft drinks and sports drinks, as well as other aqueous systems, without precipitation of protein. The pulse protein product is preferably an isolate having a protein content of at least about 90 wt % (N×6.25) d.b., preferably at least about 100 wt % (N×6.25) d.b.

In one aspect of the present invention, a pulse protein source material is extracted with aqueous calcium chloride solution at natural pH and the resulting aqueous pulse protein solution is subjected to optional ultrafiltration and optional diafiltration to provide an optionally concentrated and optionally diafiltered pulse protein solution, which may be dried to provide the pulse protein product.

In accordance with one aspect of the present invention, there is provided a method of producing a pulse protein product having a pulse protein content of at least 60 wt % (N×6.25), on a dry weight basis, which comprises:
(a) extracting a pulse protein source with an aqueous calcium salt solution, preferably an aqueous calcium chloride solution, to cause solubilization of pulse protein from the protein source and to form an aqueous pulse protein solution,
(b) separating the aqueous pulse protein solution from residual pulse protein source,
(c) optionally concentrating the aqueous pulse protein solution while maintaining the ionic strength substantially constant by using a selective membrane technique,
(d) optionally diafiltering the optionally concentrated pulse protein solution, and
(e) optionally drying the optionally concentrated and optionally diafiltered pulse protein solution.

The pulse protein product is preferably an isolate having a protein content of at least about 90 wt % (N×6.25) d.b., preferably at least about 100 wt % (N×6.25) d.b.

In a variation of the procedure described above, the protein solution may be pH adjusted to a pH of about 6 to about 8 immediately prior to the optional drying step. This pH adjustment facilitates the use of the product in food applications having a near neutral pH.

According to an additional aspect of the present invention, there is provided a method of producing a pulse protein product having a pulse protein content of at least about 60 wt % (N×6.25), dry weight basis, which comprises:
(a) extracting a pulse protein source with an aqueous calcium salt solution, preferably an aqueous calcium chloride solution, to cause solubilization of pulse protein from the protein source and to form an aqueous pulse protein solution,
(b) separating the aqueous pulse protein solution from residual pulse protein source,
(c) optionally concentrating the aqueous pulse protein solution while maintaining the ionic strength substantially constant by using a selective membrane technique,
(d) optionally diafiltering the optionally concentrated pulse protein solution,
(e) adjusting the pH of the optionally concentrated and optionally diafiltered pulse protein solution to a pH of about 6 to about 8, and
(f) optionally drying the resulting solution.

Alternatively, partially concentrated or fully concentrated and optionally diafiltered pulse protein solution may be pH-adjusted to about 1.5 to about 4.4, preferably about 2.0 to about 4.0. The acidified pulse protein solution may be subjected to a heat treatment to inactivate heat labile anti-nutritional factors, such as trypsin inhibitors.

According to a further aspect of the present invention, there is provided a method of producing a pulse protein product having a pulse protein content of at least about 60 wt % (N×6.25) on a dry weight basis, which comprises:
(a) extracting a pulse protein source with an aqueous calcium salt solution, preferably an aqueous calcium chloride solution, to cause solubilization of pulse protein from the protein source and to form an aqueous pulse protein solution,
(b) separating the aqueous pulse protein solution from residual pulse protein source,
(c) optionally concentrating the aqueous pulse protein solution while maintaining the ionic strength substantially constant by using a selective membrane technique,
(d) adjusting the pH of the optionally partially or fully concentrated pulse protein solution to a pH of about 1.5 to about 4.4, preferably about 2.0 to about 4.0, and
(e) optionally drying the resulting solution.

Employing the procedures of the present invention allows the option of production of the pulse protein product in a natural pH form. Such generation of the pulse protein product without a pH adjustment step allows easier, safer and more economical processing, since there is no need for acids or bases and their handling. In addition, this procedure permits the beverage formulator to acidify the protein and beverage with the acidifying agent of their choice, given the differing strengths and flavour profiles of various acids.

While the present invention refers mainly to the production of pulse protein isolates, it is contemplated that pulse protein products of lesser purity may be provided having similar properties to the pulse protein isolate. Such lesser purity products may have a protein concentration of at least about 60% by weight (N×6.25) d.b.

The novel pulse protein products of the invention can be blended with powdered drinks for the formation of aqueous soft drinks or sports drinks by dissolving the same in water. Such blend may be a powdered beverage.

The pulse protein products provided herein may be provided as an aqueous solution thereof. Such solutions are preferably transparent at a pH value of less than about 4.4 and are heat stable at these pH values.

In another aspect of the present invention, there is provided an aqueous solution of the pulse product provided herein which is heat stable at low pH. The aqueous solution may be a beverage, which may be a clear beverage in which the pulse protein product is completely soluble and transparent or a non-transparent beverage such as a translucent or opaque beverage in which the pulse protein product does or does not increase the opacity.

The pulse protein products produced according to the processes herein are suitable, not only for protein fortification of acid medium, but may be used in a wide variety of conventional applications of protein isolates, including, but not limited to, protein fortification of processed foods and beverages, emulsification of oils, as a body former in baked goods and foaming agent in products which entrap gases. In addition, the pulse protein product may be formed into protein fibers, useful in meat analogs and may be used as an egg white substitute or extender in food products where egg white is used as a binder. The pulse protein product may be used as a nutritional supplement. The pulse protein product may also be used in dairy analog or dairy alternative products or products which are dairy/pulse blends. Other uses of the pulse protein product are in pet foods, animal feed and in industrial and cosmetic applications and in personal care products.

### GENERAL DESCRIPTION OF INVENTION

The initial step of the process of providing the pulse protein products involves solubilizing pulse protein from a pulse protein source. The pulses to which the invention may be applied include lentils, chickpeas, dry peas and dry beans. The pulse protein source may be pulses or any pulse product or by-product derived from the processing of pulses. For example, the pulse protein source may be a flour prepared by grinding an optionally dehulled pulse. As another example, the pulse protein source may be a protein-rich pulse fraction formed by dehulling and grinding a pulse and then air classifying the dehulled and ground material into starch-rich and protein-rich fractions. The pulse protein product recovered from the pulse protein source may be the protein naturally occurring in pulses or the proteinaceous material may be a protein modified by genetic manipulation but possessing characteristic hydrophobic and polar properties of the natural protein.

Protein solubilization from the pulse protein source material is effected most conveniently using food grade calcium chloride solution, although solutions of other calcium salts may be used. Where the pulse protein product is intended for non-food uses, non-food-grade chemicals may be used. In addition, other alkaline earth metal salts may be also used, such as magnesium salts. Further, extraction of the pulse protein from the pulse protein source may also be effected using calcium salt solution in combination with another salt solution, such as sodium chloride. Additionally, extraction of the pulse protein from the pulse protein source may be effected using water or other salt solution, such as sodium chloride solution, with calcium salt, such as calcium chloride, subsequently being added to the aqueous pulse protein solution produced in the extraction step. Precipitate formed upon addition of the calcium salt then is removed prior to subsequent processing.

As the concentration of the calcium salt solution increases, the degree of solubilization of protein from the pulse protein source initially increases until a maximum value is achieved. Any subsequent increase in salt concentration does not increase the total protein solubilized. The concentration of the calcium salt solution which causes maximum protein solubilization varies depending on the salt concerned. It is usually preferred to utilize a concentration value less than about 1.0 M, and more preferably a value of about 0.10 M to about 0.15 M.

In a batch process, the salt solubilization of the protein is effected at a temperature of from about 1° C. to about 100° C., preferably about 15° C. to about 65° C., more preferably about 20° to about 35° C., preferably accompanied by agitation to decrease the solubilization time, which is usually about 1 to about 60 minutes. It is preferred to effect the solubilization to extract substantially as much protein from the pulse protein source as is practicable, so as to provide an overall high product yield.

In a continuous process, the extraction of the pulse protein from the pulse protein source is carried out in any manner consistent with effecting a continuous extraction of pulse protein from the pulse protein source. In one embodiment, the pulse protein source is continuously mixed with the calcium salt solution and the mixture is conveyed through a pipe or conduit having a length and at a flow rate for a residence time sufficient to effect the desired extraction in accordance with the parameters described herein. In such a continuous procedure, the salt solubilization step is effected in a time of about 1 minute to about 60 minutes, preferably to effect solubilization to extract substantially as much protein from the pulse protein source as is practicable. The solubilization in the continuous procedure is effected at temperatures between about 1° C. and about 100° C., preferably between about 15° C. and about 65° C., more preferably about 20° to about 35° C.

The extraction is generally conducted at a pH of about 4.5 to about 11, preferably about 5 to about 7. The pH of the extraction system (pulse protein source and calcium salt solution) may be adjusted, if necessary, to any desired value within the range of about 4.5 to about 11 for use in the extraction step by the use of any convenient acid, usually hydrochloric acid, or alkali, usually sodium hydroxide, as required.

The concentration of pulse protein source in the calcium salt solution during the solubilization step may vary widely. Typical concentration values are about 5 to about 15% w/v.

The protein solution resulting from the extraction step generally has a protein concentration of about 5 to about 50 g/L, preferably about 10 to about 50 g/L.

The protein extraction step with the aqueous salt solution has the additional effect of solubilizing fats which may be present in the pulse protein source, which then results in the fats being present in the aqueous phase.

The aqueous calcium salt solution may contain an antioxidant. The antioxidant may be any convenient antioxidant, such as sodium sulfite or ascorbic acid. The quantity of antioxidant employed may vary from about 0.01 to about 1 wt % of the solution, preferably about 0.05 wt %. The antioxidant serves to inhibit the oxidation of any phenolics in the protein solution.

The aqueous phase resulting from the extraction step then may be separated from the residual pulse protein source, in any convenient manner, such as by employing a decanter centrifuge, followed by disc centrifugation and/or filtration, to remove residual pulse protein source material. The separation step may be conducted at any temperature within the range of about 1° to about 100° C., preferably about 15° to about 65° C., more preferably about 50° to about 60° C. The separated residual pulse protein source may be dried for disposal or further processed, such as to recover starch and/or residual protein. Residual protein may be recovered by re-extracting the separated residual pulse protein source with fresh calcium salt solution and the protein solution yielded upon clarification combined with the initial protein solution for further processing as described below. Alternatively, the separated residual pulse protein source may be processed by a conventional isoelectric precipitation process or any other convenient procedure to recover residual protein.

The aqueous pulse protein solution may be treated with an anti-foamer, such as any suitable food-grade, non-silicone based anti-foamer, to reduce the volume of foam formed upon further processing. The quantity of anti-foamer employed is generally greater than about 0.0003% w/v. Alternatively, the anti-foamer in the quantity described may be added in the extraction steps.

The separated aqueous pulse protein solution may be subject to a defatting operation, if required, as described in U.S. Pat. Nos. 5,844,086 and 6,005,076, assigned to the assignee hereof and the disclosures of which are incorporated herein by reference. Alternatively, defatting of the separated aqueous pulse protein solution may be achieved by any other convenient procedure.

The aqueous pulse protein solution may be treated with an adsorbent, such as powdered activated carbon or granulated activated carbon, to remove colour and/or odour compounds. Such adsorbent treatment may be carried out under any convenient conditions, generally at the ambient temperature of the separated aqueous protein solution. For powdered activated carbon, an amount of about 0.025% to about 5% w/v, preferably about 0.05% to about 2% w/v, is employed. The adsorbing agent may be removed from the pulse solution by any convenient means, such as by filtration.

If of adequate purity, the resulting aqueous pulse protein solution may be directly dried to produce a pulse protein product. To decrease the impurities content, the aqueous pulse protein solution may be processed prior to drying.

The aqueous pulse protein solution may be concentrated to increase the protein concentration thereof while maintaining the ionic strength thereof substantially constant. Such concentration generally is effected to provide a concentrated pulse protein solution having a protein concentration of about 50 to about 400 g/L, preferably about 100 to about 250 g/L.

The concentration step may be effected in any convenient manner consistent with batch or continuous operation, such as by employing any convenient selective membrane technique, such as ultrafiltration or diafiltration, using membranes, such as hollow-fibre membranes or spiral-wound membranes, with a suitable molecular weight cut-off, such as about 1,000 to about 1,000,000 daltons, preferably about 1,000 to about 100,000 daltons, having regard to differing membrane materials and configurations, and, for continuous operation, dimensioned to permit the desired degree of concentration as the aqueous protein solution passes through the membranes.

As is well known, ultrafiltration and similar selective membrane techniques permit low molecular weight species to pass therethrough while preventing higher molecular weight species from so doing. The low molecular weight species include not only the ionic species of the food grade salt but also low molecular weight materials extracted from the source material, such as carbohydrates, pigments, low molecular weight proteins and anti-nutritional factors, such as trypsin inhibitors, which are themselves low molecular weight proteins. The molecular weight cut-off of the membrane is usually chosen to ensure retention of a significant proportion of the protein in the solution, while permitting contaminants to pass through having regard to the different membrane materials and configurations.

The concentrated pulse protein solution then may be subjected to a diafiltration step using calcium salt solution, such as a solution of calcium chloride at the same pH and the same concentration of calcium salt as the extraction solution. If a reduction in the salt content of the retentate is desired, the diafiltration solution employed may be an aqueous calcium salt solution at the same pH but lower salt concentration than the extraction solution. However, the salt concentration of the diafiltration solution must be chosen so that the salt level in the retentate remains sufficiently high to maintain the desired protein solubility. As mentioned, the diafiltration solution is preferably at a pH equal to that of the protein solution being diafiltered. The pH of the diafiltration solution may be adjusted with any convenient acid, such as hydrochloric acid or phosphoric acid or alkali, such as sodium hydroxide. Such diafiltration may be effected using from about 1 to about 40 volumes of diafiltration solution, preferably about 2 to about 25 volumes of diafiltration solution. In the diafiltration operation, further quantities of contaminants are removed from the aqueous pulse protein solution by passage through the membrane with the permeate. The diafiltration operation may be effected until no significant further quantities of contaminants or visible colour are present in the permeate or until the retentate has been sufficiently purified so as, when dried, to provide a pulse protein product with the desired protein content, preferably an isolate with a protein content of at least about 90 wt % on a dry weight basis. Such diafiltration may be effected using the same membrane as for the concentration step. However, if desired, the diafiltration step may be effected using a separate membrane with a different molecular weight cut-off, such as a membrane having a molecular weight cut-off in the range of about 1,000 to about 1,000,000 daltons, preferably about 1,000 to about 100,000 daltons, having regard to different membrane materials and configuration.

Alternatively, the diafiltration step may be applied, as described above, to the aqueous protein solution prior to concentration or to a partially concentrated aqueous protein solution. When diafiltration is applied prior to concentration or to the partially concentrated solution, the resulting diafiltered solution may then be additionally concentrated.

The concentration step and the diafiltration step may be effected herein in such a manner that the pulse protein product subsequently recovered by drying the concentrated and diafiltered protein solution contains less than about 90 wt % protein (N×6.25) d.b., such as at least about 60 wt % protein (N×6.25) d.b. By partially concentrating and/or partially diafiltering the aqueous pulse protein solution, it is possible to only partially remove contaminants. This protein solution may then be dried to provide a pulse protein product with lower levels of purity. The pulse protein product is still soluble under acidic conditions.

An antioxidant may be present in the diafiltration medium during at least part of the diafiltration step. The antioxidant may be any convenient antioxidant, such as sodium sulfite or ascorbic acid. The quantity of antioxidant employed in the diafiltration medium depends on the materials employed and may vary from about 0.01 to about 1 wt %, preferably about 0.05 wt %. The antioxidant serves to inhibit the oxidation of any phenolics present in the pulse protein solution.

The optional concentration step and the optional diafiltration step may be effected at any convenient temperature, generally about 2° to about 65° C., preferably about 50° to about 60° C., and for the period of time to effect the desired degree of concentration and diafiltration. The temperature and other conditions used to some degree depend upon the membrane equipment used to effect the membrane processing, the desired protein concentration of the solution and the efficiency of the removal of contaminants to the permeate.

Pulses contain anti-nutritional trypsin inhibitors. The level of trypsin inhibitor activity in the final pulse protein product can be controlled by the manipulation of various process variables.

For example, the concentration and/or diafiltration steps may be operated in a manner favorable for removal of trypsin inhibitors in the permeate along with the other contaminants. Removal of the trypsin inhibitors is promoted by using a membrane of larger pore size, such as about 30,000 to about. 1,000,000 daltons, operating the membrane at elevated temperatures, such as about 30° to about 65° C., preferably about 50° to about 60° C. and employing greater volumes of diafiltration medium, such as about 10 to about 40 volumes.

Further, a reduction in trypsin inhibitor activity may be achieved by exposing pulse materials to reducing agents that disrupt or rearrange the disulfide bonds of the inhibitors. Suitable reducing agents include sodium sulfite, cysteine and N-acetylcysteine.

The addition of such reducing agents may be effected at various stages of the overall process. For example, the reducing agent may be added with the pulse protein source material in the extraction step, may be added to the clarified aqueous pulse protein solution following removal of residual pulse protein source material, may be added to the concentrated protein solution before or after diafiltration or may be dry blended with the dried pulse protein product. The addition of the reducing agent may be combined with the membrane processing steps, as described above.

If it is desired to retain active trypsin inhibitors in the protein solution, this can be achieved by utilizing a concentration and/or diafiltration membrane with a smaller pore size, operating the membrane at lower temperatures, employing fewer volumes of diafiltration medium and not employing a reducing agent.

The optionally concentrated and optionally diafiltered protein solution may be subject to a further defatting operation, if required, as described in U.S. Pat. Nos. 5,844,086 and 6,005,076. Alternatively, defatting of the optionally concentrated and optionally diafiltered protein solution may be achieved by any other convenient procedure.

The optionally concentrated and optionally diafiltered aqueous protein solution may be treated with an adsorbent, such as powdered activated carbon or granulated activated carbon, to remove colour and/or odour compounds. Such adsorbent treatment may be carried out under any convenient conditions, generally at the ambient temperature of the aqueous protein solution. For powdered activated carbon, an amount of about 0.025% to about 5% w/v, preferably about 0.05% to about 2% w/v, is employed. The adsorbent may be removed from the pulse protein solution by any convenient means, such as by filtration.

The optionally concentrated and optionally diafiltered pulse protein solution resulting from the optional defatting and optional adsorbent treatment step may be subjected to a pasteurization step to reduce the microbial load. Such pasteurization may be effected under any desired pasteurization conditions. Generally, the optionally concentrated and optionally diafiltered pulse protein solution is heated to a temperature of about 55° to about 70° C., preferably about 60° to about 65° C., for about 30 seconds to about 60 minutes, preferably about 10 to about 15 minutes. The pasteurized pulse protein solution then may be cooled for drying or further processing, preferably to a temperature of about 15° to about 35° C.

If desired, the optionally concentrated and optional diafiltered pulse protein solution may be polished by any convenient means, such as by filtering to remove any residual particulates.

In accordance with one aspect of the current invention, the optionally concentrated and optionally diafiltered aqueous pulse protein solution may be dried by any convenient technique, such as spray drying or freeze drying, to yield the pulse protein product. The pulse protein product is low in phytic acid content, generally less than about 1.5% by weight d.b.

In accordance with another aspect of the current invention, the optionally concentrated and optionally diafiltered aqueous pulse protein solution may be adjusted in pH to about 6.0 to about 8.0 by the addition of any convenient alkali, usually sodium hydroxide. The resulting pH adjusted protein solution then may be dried. Alternatively, the partially concentrated or fully concentrated and optionally diafiltered pulse protein solution may be adjusted in pH to about 1.5 to about 4.4, preferably about 2.0 to about 4.0. The pH adjustment may be effected in any convenient manner, such as by the addition of hydrochloric acid or phosphoric acid. The resulting acidified pulse protein solution may be polished as described above then may be dried. As a further alternative, the acidified pulse protein solution may be subjected to a heat treatment to inactivate heat labile anti-nutritional factors, such as the trypsin inhibitors mentioned above. Such a heating step also provides the additional benefit of reducing the microbial load. Generally, the protein solution is heated to a temperature of about 70° to about 160° C., for about 10 seconds to about 60 minutes, preferably about 80° to about 120° C., for about 10 seconds to about 5 minutes, more preferably about 85° to about 95° C., for about 30 seconds to about 5 minutes. The heat treated acidified pulse protein solution then may be cooled to a temperature of about 2° C. to about 65° C., preferably about 20° to about 35° C. The resulting acidified, heat treated pulse protein solution may be polished as described above then may be dried.

The pulse protein products produced herein are soluble in an acidic aqueous environment, making the products ideal for incorporation into acidic beverages, both carbonated and uncarbonated, to provide protein fortification thereto. Such beverages have a wide range of acidic pH values, ranging from about 2.5 to about 5. The pulse protein products provided herein may be added to such beverages in any convenient quantity to provide protein fortification to such beverages, for example, at least about 5 g of the pulse protein per serving. The added pulse protein product dissolves in the beverage and remains soluble after thermal processing.

The pulse protein product may be blended with dried beverage prior to reconstitution of the beverage by dissolution in water.

In some cases, modification of the normal formulation of beverages to tolerate the composition of the invention may be necessary where components present in the beverage may adversely affect the ability of the composition to remain dissolved in the beverage.

The pulse protein products produced herein may also be used in solution at near neutral pH values of about 6 to about 8. Such an aqueous solution of the pulse protein product may be a beverage. The aqueous solution of pulse protein product prepared at near neutral pH may also be utilized in the production of any food application that makes use of a protein product in solution at near neutral pH, such as a plant based dairy analog or alternative, such as a pulse milk type beverage or pulse ice cream like frozen dessert, or a dairy type product containing a mix of dairy and plant ingredients.

In addition to the food applications mentioned above, the pulse protein products produced herein may also be utilized in a variety of other food applications such as nutritional bars, processed meats and baked goods.

### EXAMPLES

### Example 1

This Example illustrates the production of pea protein isolate that is membrane processed at natural pH.

30 kg of pea protein concentrate, prepared by air classifying flour made by grinding yellow split peas, was added to 300 L of 0.15 M CaCl₂ solution at 60° C. and agitated for 30 minutes to provide an aqueous protein solution. The residual pea protein concentrate was removed and the resulting protein solution was clarified by centrifugation and filtration to produce a solution having a protein content of 3.14% by weight.

The filtered protein solution was reduced in volume from 225 L to 60 L by concentration on a PES membrane having a molecular weight cutoff of 10,000 daltons, operated at a temperature of about 51° C. The concentrated protein solution was diafiltered with 600 L of 0.075M CaCl₂, with the diafiltration operation conducted at a temperature of about 59° C. The resulting diafiltered, concentrated protein solution, had a weight of 61.64 kg, a protein content of 9.08% by weight and represented a yield of 79.2 wt % of the filtered protein solution. The diafiltered, concentrated protein solution was spray dried to yield a product found to have a protein content of 95.67 wt % (N×6.25) d.b. The product was termed YP03-L08-11A YP702.

### Example 2

This Example illustrates the colour of the pea protein isolate prepared by the method of Examples 1 and 8 (below) in solution and in dry powder form.

A solution of YP03-L08-1 1 A YP702 was prepared by dissolving sufficient protein powder to supply 0.48 g of protein in 15 ml of RO water and the colour and clarity assessed using a HunterLab ColorQuest XE instrument operated in transmission mode. The pH was also measured with a pH meter.

The pH, colour and clarity values are set forth in the following Table 1.

TABLE 1
pH and HunterLab readings for solution of YP03-L08-11A YP702

| sample | pH | L* | a* | b* | haze (%) |
|---|---|---|---|---|---|
| YP03-L08-11A YP702 | 5.60 | 88.37 | 1.88 | 6.17 | 96.9 |
| YP08-F28-12A YP702 | 5.41 | 45.03 | 7.62 | 54.44 | 96.8 |

The colour of the dry powder was also assessed using the HunterLab ColorQuest XE instrument in reflectance mode. The colour values are set forth in the following Table 2.

TABLE 2
HunterLab readings for YP03-L08-11A YP702 dry powder

| sample | L* | a* | b* |
|---|---|---|---|
| YP03-L08-11A YP702 | 85.59 | 3.22 | 7.75 |
| YP08-F28-12A YP702 | 85.74 | 3.27 | 10.95 |

As may be seen from Table 2, the dry colour of the YP702 powders was very light.

### Example 3

This Example contains an evaluation of the heat stability of the pea protein isolate produced by the method of Example 1 in water at pH 3.

A 2% w/v protein solution of YP03-L08-11A YP702 in water was produced and the pH adjusted to 3 with diluted HCl. The clarity of this protein solution was assessed by haze measurement with the HunterLab ColorQuest XE instrument. The solution was then heated to 95° C., held at this temperature for 30 seconds and then immediately cooled to room temperature in an ice water bath. The clarity of the heat treated solution was then measured again.

The clarity of the protein solution before and after heating is set forth in the following Table 3.

TABLE 3
Effect of heat treatment on clarity of
YP03-L08-11A YP702 solution at pH 3

| sample | haze (%) |
|---|---|
| before heating | 81.6 |
| after heating | 36.0 |

As can be seen from the results in Table 3, the heat treatment did not impair the clarity of the sample. In fact, the level of haze in the sample was reduced by the heat treatment.

### Example 4

This Example contains an evaluation of the solubility in water of the pea protein isolate produced by the method of Example 1. Solubility was tested based on protein solubility (termed protein method, a modified version of the procedure of Morr et al., J. Food Sci. 50:1715-1718) and total product solubility (termed pellet method).

Sufficient protein powder to supply 0.5 g of protein was weighed into a beaker and then a small amount of reverse osmosis (RO) purified water was added and the mixture stirred until a smooth paste formed. Additional water was then added to bring the volume to approximately 45 ml. The contents of the beaker were then slowly stirred for 60 minutes using a magnetic stirrer. The pH was determined immediately after dispersing the protein and was adjusted to the appropriate level (2, 3, 4, 5, 6 or 7) with diluted NaOH or HCl. A sample was also prepared at natural pH. For the pH adjusted samples, the pH was measured and corrected periodically during the 60 minutes stirring. After the 60 minutes of stirring, the samples were made up to 50 ml total volume with RO water, yielding a 1% w/v protein dispersion. The protein content of the dispersions was measured by combustion analysis using a Leco Truspec N Nitrogen Determinator. Aliquots (20 ml) of the dispersions were then transferred to pre-weighed centrifuge tubes that had been dried overnight in a 100° C. oven then cooled in a desiccator and the tubes capped. The samples were centrifuged at 7,800 g for 10 minutes, which sedimented insoluble material and yielded a supernatant. The protein content of the supernatant was measured by combustion analysis and then the supernatant and the tube lids were discarded and the pellet material dried overnight in an oven set at 100° C. The next morning the tubes were transferred to a desiccator and allowed to cool. The weight of dry pellet material was recorded. The dry weight of the initial protein powder was calculated by multiplying the weight of powder used by a factor of ((100—moisture content of the powder (%))/100). Solubility of the product was then calculated two different ways:

Solubility (protein method) (%)=(% protein in supernatant/% protein in initial dispersion)×100 1)

Solubility (pellet method) (%)=(1—(weight dry insoluble pellet material/((weight of 20 ml of dispersion/weight of 50 ml of dispersion)×initial weight dry protein powder)))×100 2)

Values calculated as greater than 100% were expressed as 100%.

The natural pH of the protein isolate produced in Example 1 in water (1% protein) was 5.79.

The solubility results obtained are set forth in the following Tables 4 and 5.

TABLE 4
Solubility of YP03-L08-11A YP702 at different
pH values based on protein method

| | Solubility (protein method) (%) | | | | | | |
|---|---|---|---|---|---|---|---|
| | | | | | | | Nat. |
| Product | pH 2 | pH 3 | pH 4 | pH 5 | pH 6 | pH 7 | pH |
| YP03-L08-11A YP702 | 94.8 | 100 | 100 | 71.7 | 18.5 | 16.4 | 22.6 |

TABLE 5
Solubility of YP03-L08-11A YP702 at different
pH values based on pellet method

| | Solubility (pellet method) (%) | | | | | | |
|---|---|---|---|---|---|---|---|
| | | | | | | | Nat. |
| Product | pH 2 | pH 3 | pH 4 | pH 5 | pH 6 | pH 7 | pH |
| YP03-L08-11A YP702 | 96.9 | 96.5 | 94.8 | 43.4 | 33.9 | 38.3 | 33.9 |

As can be seen from the results of Tables 4 and 5, the YP702 product was very soluble in the range of pH 2 to 4.

### Example 5

This Example contains an evaluation of the clarity in water of the pea protein isolate produced by the method of Example 1.

The clarity of the 1% w/v protein dispersions prepared as described in Example 4 was assessed by measuring the absorbance at 600 nm (water blank), with a lower absorbance score indicating greater clarity. Analysis of the samples on the HunterLab ColorQuest XE instrument in transmission mode also provided a percentage haze reading, another measure of clarity.

The clarity results are set forth in the following Tables 6 and 7.

TABLE 6
Clarity of YP03-L08-11A YP702 solution at
different pH values as assessed by A600

| | A600 | | | | | | |
|---|---|---|---|---|---|---|---|
| | | | | | | | Nat. |
| Product | pH 2 | pH 3 | pH 4 | pH 5 | pH 6 | pH 7 | pH |
| YP03-L08-11A YP702 | 0.112 | 0.299 | 0.475 | 1.789 | 0.673 | 0.441 | 0.545 |

TABLE 7
Clarity of YP03-L08-11A YP702 solution at different
pH values as assessed by HunterLab analysis

| | HunterLab haze reading (%) | | | | | | |
|---|---|---|---|---|---|---|---|
| | | | | | | | Nat. |
| Product | pH 2 | pH 3 | pH 4 | pH 5 | pH 6 | pH 7 | pH |
| YP03-L08-11A YP702 | 32.4 | 63.2 | 79.2 | 98.7 | 96.2 | 78.8 | 76.9 |

As may be seen from the results in Tables 6 and 7, the solutions were not clear, but the lowest haze readings were seen at the lowest pH values.

### Example 6

This Example contains an evaluation of the protein solubility in a soft drink and sports drink of the pea protein isolate produced by the method of Example 1. The solubility was determined with the protein added to the beverages with no pH correction and again with the pH of the protein fortified beverages adjusted to the level of the original beverages.

When the solubility was assessed with no pH correction, a sufficient amount of protein powder to supply 1 g of protein was weighed into a beaker and a small amount of beverage was added and stirred until a smooth paste formed. Additional beverage was added to bring the volume to 50 ml, and then the solutions were stirred slowly on a magnetic stirrer for 60 minutes to yield a 2% protein w/v dispersion. The protein content of the samples was determined by combustion analysis using a LECO TruSpec N Nitrogen Determinator then an aliquot of the protein containing beverages was centrifuged at 7,800 g for 10 minutes and the protein content of the supernatant measured.

Solubility (%)=(% protein in supernatanti% protein in initial dispersion)×100

When the solubility was assessed with pH correction, the pH of the soft drink (Sprite) (3.37) and sports drink (Orange Gatorade) (3.07) without protein was measured. A sufficient amount of protein powder to supply 1 g of protein was weighed into a beaker and a small amount of beverage was added and stirred until a smooth paste formed. Additional beverage was added to bring the volume to approximately 45 ml, and then the solutions were stirred slowly on a magnetic stirrer for 60 minutes. The pH of the protein containing beverages was determined immediately after dispersing the protein and was adjusted to the original no-protein pH with HCl or NaOH solution as necessary. The pH was measured and corrected periodically during the 60 minutes stirring. After the 60 minutes of stirring, the total volume of each solution was brought to 50 ml with additional beverage, yielding a 2% protein w/v dispersion. The protein content of the samples was determined by combustion analysis using a Leco TruSpec N Nitrogen Determinator then an aliquot of the protein containing beverages was centrifuged at 7,800 g for 10 minutes and the protein content of the supernatant measured.

Solubility (%)=(% protein in supernatant/% protein in initial dispersion)×100

The results obtained are set forth in the following Table 8.

TABLE 8
Solubility of YP03-L08-11A YP702 in Sprite and Orange Gatorade

| | no pH correction | | pH correction | |
|---|---|---|---|---|
| | | Solubil- | | Solubil- |
| | Solubil- | ity (%) | Solubil- | ity (%) |
| | ity (%) | in Orange | ity (%) | in Orange |
| Product | in Sprite | Gatorade | in Sprite | Gatorade |
| YP03-L08-11A | 95.3 | 95.1 | 95.9 | 98.0 |
| YP702 | | | | |

As can be seen from the results of Table 8, the YP702 protein was highly soluble in both the Sprite and the Orange Gatorade. Note that the YP03-L08-11A YP702 had a near-neutral natural pH in water but the slightly higher pH of the non-corrected beverage samples appeared to have little effect on the solubility.

### Example 7

This Example contains an evaluation of the clarity in a soft drink and sports drink of the pea protein isolate produced by the method of Example 1.

The clarity of the 2% w/v protein dispersions prepared in soft drink (Sprite) and sports drink (Orange Gatorade) in Example 6 were assessed using the HunterLab method described in Example 5.

The results obtained are set forth in the following Table 9.

TABLE 9
HunterLab haze readings for YP702 in Sprite and Orange Gatorade

| | no pH correction | | pH correction | |
|---|---|---|---|---|
| | | haze (%) | | haze (%) |
| | haze (%) | in Orange | haze (%) | in Orange |
| Product | in Sprite | Gatorade | in Sprite | Gatorade |
| no protein | 0.0 | 63.6 | | |
| YP03-L08-11A YP702 | 91.1 | 92.6 | 83.7 | 90.0 |

As can be seen from the results in Table 9, despite the excellent protein solubility, the YP03-L08-11A YP702 contributed haze to the Sprite and Orange Gatorade. Correcting the pH reduced the haze level only slightly.

### Example 8

This Example illustrates the production of a pea protein product that is membrane processed at natural pH but has a protein content of less than 90% d.b.

48 kg of yellow pea flour was added to 300 L of RO water at ambient temperature and agitated for 30 minutes to provide an aqueous protein solution. The bulk of the spent yellow pea flour was removed by centrifugation to provide a partially clarified protein solution. To the partially clarified protein solution was added 6.84 kg of calcium chloride solution, prepared by combining dry calcium chloride and RO water in the ratio 1 kg calcium chloride:2 L water, and the sample mixed for an additional 15 minutes. The addition of the calcium chloride solution resulted in the formation of a precipitate. The conductivity of the protein solution after calcium chloride addition was 12.37 mS. The temperature of the solution was raised to about 50° C. and then the sample, having a volume of 250 L and a protein content of 2.75 wt %, was clarified by centrifugation to provide a solution having a protein content of 1.53 wt %.

The clarified protein solution was reduced from 225 L to 24.95 kg by concentration on a PES membrane having a molecular weight cutoff of 3,000 daltons, operated at a temperature of about 52° C. The concentrated protein solution, having a protein content of 8.13 wt % was recovered in a yield of 29.5% of the protein solution centrifuged to remove the precipitate formed on calcium chloride addition. The concentrated protein solution was spray dried to yield a product found to have a protein content of 78.88 wt % (N×6.25) d.b. The product was termed YP08-F28-12A YP702.

### Example 9

This Example contains an evaluation of the phytic acid content of the pea protein products produced by the method of Examples 1 and 8. Phytic acid content was determined using the method of Latta and Eskin (J. Agric. Food Chem., 28: 1313-1315).

The phytic acid content of the products is shown in Table 10.

TABLE 10
Phytic acid content of protein products

| Product | % phytic acid (d.b.) |
|---|---|
| YP03-L08-11A YP702 | 0.06 |
| YP08-F28-12A YP702 | 0.01 |

As may be seen from the results presented in Table 10, the pea protein products had a very low content of phytic acid.

### SUMMARY OF THE DISCLOSURE

In summary of this disclosure, the present invention provides an alternative method based on extraction of pulse protein from source material using aqueous calcium chloride solution, to obtain a pulse protein product which is soluble in acidic media and forms heat stable solutions therein. Modifications are possible within the scope of this invention.

What we claim is:

1. A method of producing a pulse protein product having a pulse protein content of at least about 60 wt % (N×6.25), dry weight basis, which comprises:
(a) extracting a pulse protein source with an aqueous calcium salt solution to cause solubilization of pulse protein from the protein source and to form an aqueous pulse protein solution,
(b) separating the aqueous pulse protein solution from residual pulse protein source,
(c) optionally concentrating the aqueous pulse protein solution while maintaining the ionic strength substantially constant by using a selective membrane technique,
(d) optionally diafiltering the optionally concentrated pulse protein solution, and
(e) optionally drying the optionally concentrated and optionally diafiltered pulse protein solution.

2. The method of claim 1 wherein said calcium salt is calcium chloride.

3. The method of claim 2 wherein said calcium chloride solution has a concentration of less than about 1.0 M.

4. The method of claim 3 wherein said calcium chloride solution has a concentration of about 0.10 to about 0.15 M.

5. The method of claim 1 wherein said extraction step is effected at a temperature of about 15° C. to about 65° C.

6. The method of claim 5, wherein the temperature is about 20° to about 35° C.

7. The method of claim 1 wherein said extraction step is carried out at a pH of about 4.5 to about 11.

8. The method of claim 7 wherein said pH is about 5 to about 7.

9. The method of claim 1 wherein said aqueous pulse protein solution has a protein concentration of about 5 to about 50 g/L.

10. The method of claim 9 wherein said aqueous pulse protein solution has a protein concentration of about 10 to about 50 g/L.

11. The method of claim 1 wherein said aqueous calcium salt solution contains an antioxidant.

12. The method of claim 1 wherein said aqueous pulse protein solution is treated with an adsorbent to remove colour and/or odour compounds from the aqueous pulse protein solution.

13. The method of claim 1 wherein the separation of the aqueous pulse protein solution from residual pulse protein is effected at a temperature of about 15° to about 65° C.

14. The method of claim 13 wherein the temperature is about 50° to about 60° C.

15. The method of claim 1 wherein said aqueous pulse protein solution is concentrated to a protein concentration of about 50 to about 400 g/L.

16. The method of claim 15 wherein said aqueous pulse protein solution is concentrated to a protein concentration of about 100 to about 250 g/L.

17. The method of claim 1 wherein said concentration step is effected by ultrafiltration using a membrane having a molecular weight cut-off of about 1,000 to about 1,000,000 daltons.

18. The method of claim 17 wherein said concentration step is effected by ultrafiltration using a membrane having a molecular weight cut-off of about 1,000 to about 100,000 daltons.

19. The method of claim 1 wherein said diafiltration step is effected using an aqueous calcium salt solution of about the same pH and about equal or lower molarity than the extraction salt solution on the pulse protein solution before or after complete concentration thereof.

20. The method of claim 19 wherein said diafiltration step is effected using about 1 to about 40 volumes of diafiltration solution.

21. The method of claim 20 wherein said diafiltration step is effected using about 2 to about 25 volumes of diafiltration solution.

22. The method of claim 19 wherein said diafiltration is effected using a membrane having a molecular weight cut-off of about 1,000 to about 1,000,000 daltons.

23. The method of claim 22 wherein said membrane has a molecular weight cut-off of about 1,000 to about 100,000 daltons.

24. The method of claim 19 wherein said diafiltration is effected until no significant further quantities of contaminants or visible colour are present in the permeate.

25. The method of claim 19 wherein said diafiltration is effected until the retentate has been sufficiently purified so as, when dried, to provide a pulse protein isolate with a protein content of at least about 90 wt % (N×6.25) d.b.

26. The method of claim 19 where an antioxidant is present during at least part of the diafiltration step.

27. The method of claim 1 wherein said optional concentration step and optional diafiltration step are carried out at a temperature of about 2° to about 65° C.

28. The method of claim 27 wherein said temperature is about 50° to about 60° C.

29. The method of claim 1 wherein the concentration and optional diafiltration step are operated in a manner favourable to the removal of trypsin inhibitors.

30. The method of claim 1 wherein the optionally concentrated and optionally diafiltered pulse protein solution is treated with an adsorbent to remove colour and/or odour compounds.

31. The method of claim 1 wherein the optionally concentrated and optionally diafiltered pulse protein solution is subjected to a pasteurization step prior to the optional drying step.

32. The method of claim 31 wherein said pasteurization step is effected at a temperature of about 55° to about 70° C. for about 30 seconds to about 60 minutes.

33. The method of claim 32 wherein said pasteurization step is effected at a temperature of about 60° to about 65° C. for about 10 to about 15 minutes.

34. The method of claim 31 wherein said pasteurized, optionally concentrated and optionally diafiltered pulse protein solution is cooled to a temperature of about 15° C. to about 35° C. for drying or further processing.

35. The method of claim 1 wherein the optionally concentrated and optionally diafiltered pulse protein solution is polished to remove residual particulates.

36. The method of claim 1 wherein the optionally concentrated and optionally diafiltered pulse protein solution is adjusted to a pH of about 6.0 to about 8.0 prior to the optional drying step.

37. The method of claim 1 wherein partially concentrated or fully concentrated and optionally diafiltered pulse protein solution is acidified to a pH of about 1.5 to about 4.4 prior to the optional drying step.

38. The method of claim 37 wherein the pH is about 2.0 to about 4.0.

39. The method of claim 37 wherein said acidified pulse protein solution is polished to remove residual particulates.

40. The method of claim 37 wherein said acidified pulse protein solution is subjected to a heat treatment step to inactivate heat-labile anti-nutritional factors prior to the optional drying step.

41. The method of claim 40 wherein the anti-nutritional factors are heat-labile trypsin inhibitors.

42. The method of claim 40 wherein the heat treatment step also pasteurizes the aqueous protein solution.

43. The method of claim 40 wherein said heat-treatment is effected at a temperature of about 70° to about 160° C. for about 10 seconds to about sixty minutes.

44. The method of claim 43 wherein said heat-treatment is effected at a temperature of about 80° to about 120° C. for about 10 seconds to about 5 minutes.

45. The method of claim 44 wherein the heat-treatment is effected at a temperature of about 85° to about 95° C. for about 30 seconds to about 5 minutes.

46. The method of claim 40 wherein the heat-treated acidified pulse protein solution is cooled to a temperature of about 2° to about 65° C. for the optional drying step.

47. The method of claim 46 wherein the heat-treated acidified pulse protein solution is cooled to a temperature of about 20° to about 35° C. for the optional drying step.

48. The method of claim 40 wherein said acidified pulse protein solution is polished to remove residual particulates.

49. The method of claim 1 wherein a reducing agent is present during the extraction step to disrupt or rearrange the disulfide bonds of trypsin inhibitors to achieve a reduction in trypsin inhibitor activity.

50. The method of claim 1 wherein a reducing agent is present during the optional concentration and/or optional diafiltration step to disrupt or rearrange the disulfide bonds of trypsin inhibitors to achieve a reduction in trypsin inhibitor activity.

51. The method of claim 1 wherein a reducing agent is added to the optionally concentrated and optionally diafiltered pulse protein solution prior to drying and/or the dried pulse protein product to disrupt or rearrange the disulfide bonds of trypsin inhibitors to achieve a reduction in trypsin inhibitor activity.

52. The method of claim 1 wherein said pulse protein product has a protein content of about 60 to less than about 90 wt % (N×6.25). d.b. and which is a concentrate.

53. The method of claim 1 wherein said pulse protein product has a protein content of at least about 90 wt % (N×6.25). d.b. and which is an isolate.

54. The method of claim 1 wherein said pulse protein product has a protein content of at least about 100 wt % (N×6.25). d.b.

55. A pulse protein product produced by the method of claim 1.

56. A food composition comprising a pulse protein product as claimed in claim 55.

57. The food composition of claim 56 which is an acidic solution having dissolved therein the pulse protein product of claim 55.

58. The food composition of claim 57 which is a beverage.

59. The food composition of claim 56 which is a blend of the pulse protein product of claim 55 and water-soluble powdered materials for the production of aqueous solutions of the blend.

60. The food composition of claim 59 which is a powdered beverage.

61. The food composition of claim 56 which is a solution having a near neutral pH of about 6 to about 8 containing therein the pulse protein product of claim 55

62. The food composition of claim 61 which is a beverage.

63. The food composition of claim 56 which is a dairy analog or dairy alternative product.

64. The food composition of claim 56 which is a blend of dairy and pulse ingredients.

65. The food composition of claim 56 which is a processed meat product.

66. The food composition of claim 56 which is a baked good.

67. The food composition of claim 56 which is a nutrition bar.
